(19) United States
(12) Patent Application Publication
(10) Pub. No.: US 2009/0045662 A1
(43) Pub. Date: Feb. 19, 2009

(54) Head Rest for Seat

(75) Inventors: Robert J. McMillen, Tecumseh (CA); Larry D. Janzen, Harrow (CA); Isa Rosli, Windsor (CA); Alan Prettyman, Amherstburg (CA)

Correspondence Address: KANG INTELLECTUAL PROPERTY LAW, LLC, 214 ELM STREET, SUITE 106, WASHINGTON, MO, 63090, US

(73) Assignee: Schukra of North America, Ltd., Lakeshore-Tecumseh (CA)

(21) Appl. No.: 11/838,741

(22) Filed: Aug. 14, 2007

(51) Int. Cl. B60N 2/48

(52) U.S. Cl. 297/391

(57) ABSTRACT

A head rest assembly that extends when the seat back is deployed into an upright position, and retract when moved into a down or stowed position.

### CROSS-REFERENCE TO RELATED APPLICATIONS

Not Applicable

### STATEMENT REGARDING FEDERALLY SPONSORED RESEARCH

Not Applicable.

### APPENDIX

Not Applicable.

### BACKGROUND OF THE INVENTION

1. Field of the Invention

The present invention relates to head rests for seats, and more particularly, to head rests that automatically move upon movement of the seat back.

2. Related Art

Head rests for seats may be adjustable or not adjustable. For adjustable head rests, the rest may move up and down, back and forth, or both. Within the area of adjustable head rests, for seating where the seats are arranged in rows, it is sometimes desirable for the head rest to move into a default position upon the movement of the seat back.

### SUMMARY OF THE INVENTION

The invention is a head rest assembly on that is capable of telescoping and tilting, and is also able to assume a default position upon the raising of a seat back from a down or flat position into a deployed position. Specifically, as the seat back is pulled into an up or deployed position, the head rest assembly is extended. Once the seat back is locked into a deployed position, the head rest assembly may further be adjusted telescopically up-down, and rotated.

From a deployed position, the seat may be lowered into a down or stowed position. As the seat back travels to the down position, the head rest assembly retracts into the seat.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more filly understood from the detailed description and the accompanying drawings, wherein:

FIG. 1 is an engineering drawing of the present invention in multiple views;

FIG. 2 is an elevated view of the present invention attached to a seat frame, and operably connected to a lumbar support;

FIG. 3 is an elevated view of the present invention as in FIG. 2, with the addition of seat padding over the left half of the seat;

FIG. 4 is a night side view of the invention shown in FIG. 3;

FIG. 5 is a night side view of the invention shown in FIG. 2 of the present invention;

FIG. 6 is an enlarged elevated view of a portion of the head rest assembly shown in FIG. 2, showing a Bowden cable operably connected to move the assembly;

FIG. 7 is an enlarged detailed rear view of the top portion of the head rest assembly;

FIG. 8 is an enlarged top view of the top portion of the head rest assembly;

FIG. 9 is an elevated view of the head rest assembly in it fully extended position;

FIG. 10 is a side view of the embodiment of FIG. 9, as the seat frame is being pulled to an seated position;

FIG. 11 is a side view of the embodiment of FIG. 9, where the seat frame has achieved its deployed position;

FIG. 12 is a side view of the embodiment of FIG. 10, showing additional seat padding;

FIG. 13 is a top elevated view of the embodiment of FIG. 12, but with a partial cutaway view of the padding around the head rest assembly;

FIG. 14 is a side elevated view with half of the seat padding cut away;

FIG. 15 is a further side elevated view with half of the seat padding cut away;

FIG. 16 is a side view of the head rest assembly of FIG. 15;

FIG. 17 is side view of the head rest assembly of FIG. 16, without seat padding;

FIG. 18 is an elevated view of the head rest assembly of the present invention, without the seat frame.

### DETAILED DESCRIPTION OF THE PREFERRED EMBODIMENTS

The following description of the preferred embodiment(s) is merely exemplary in nature and is in no way intended to limit the invention, its application, or uses.

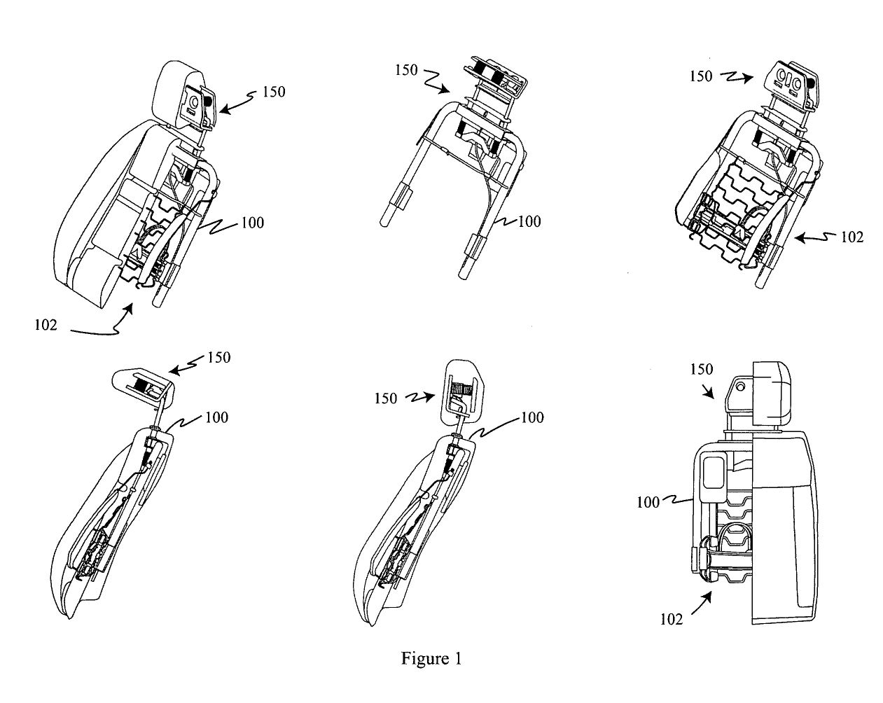

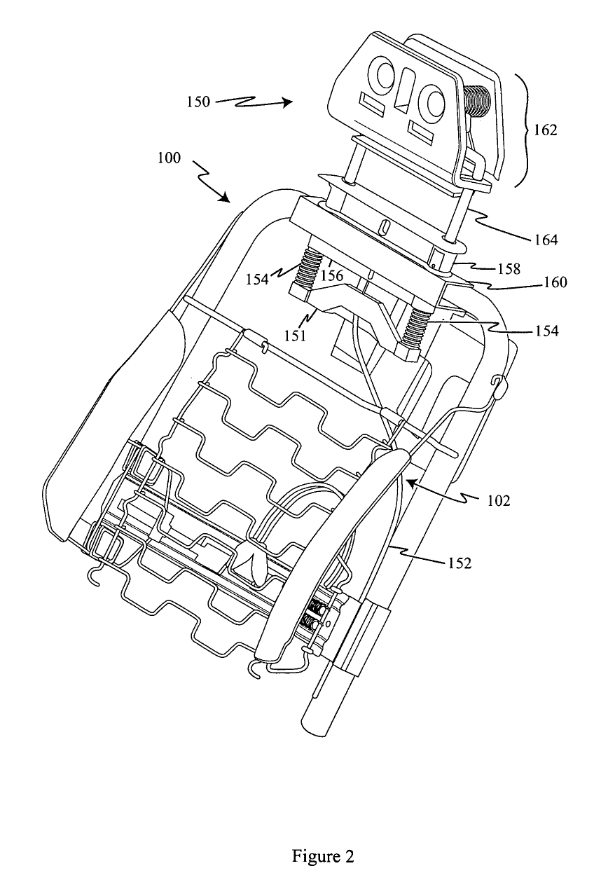

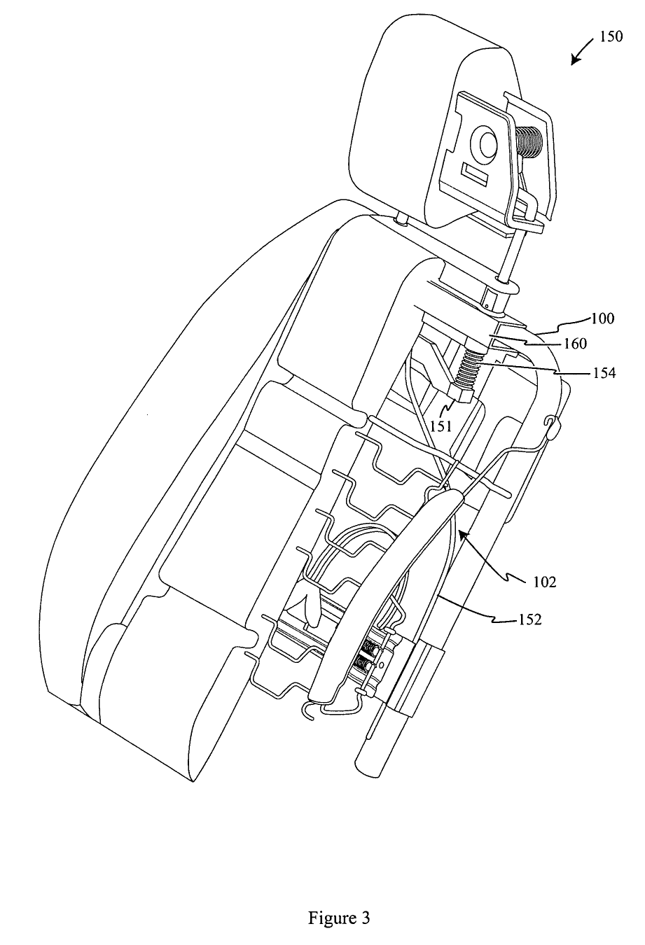

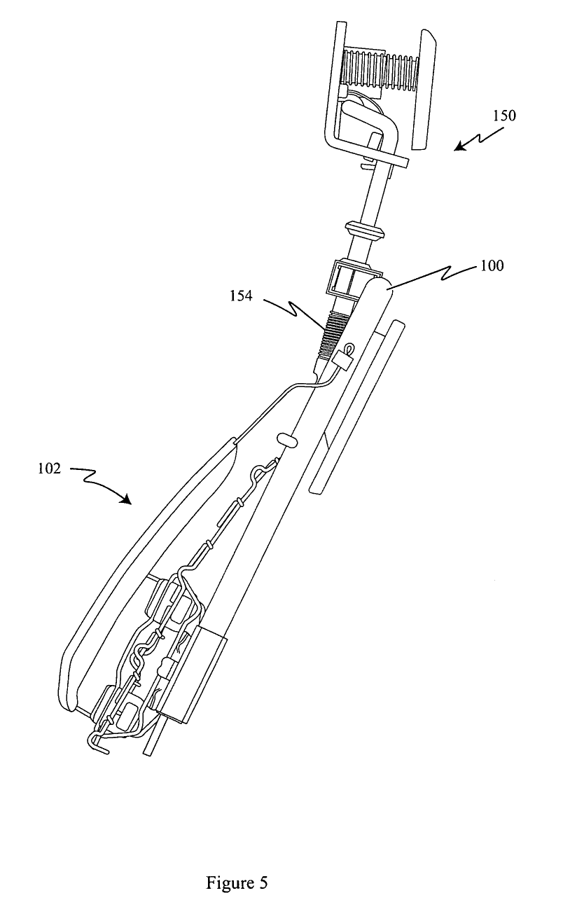

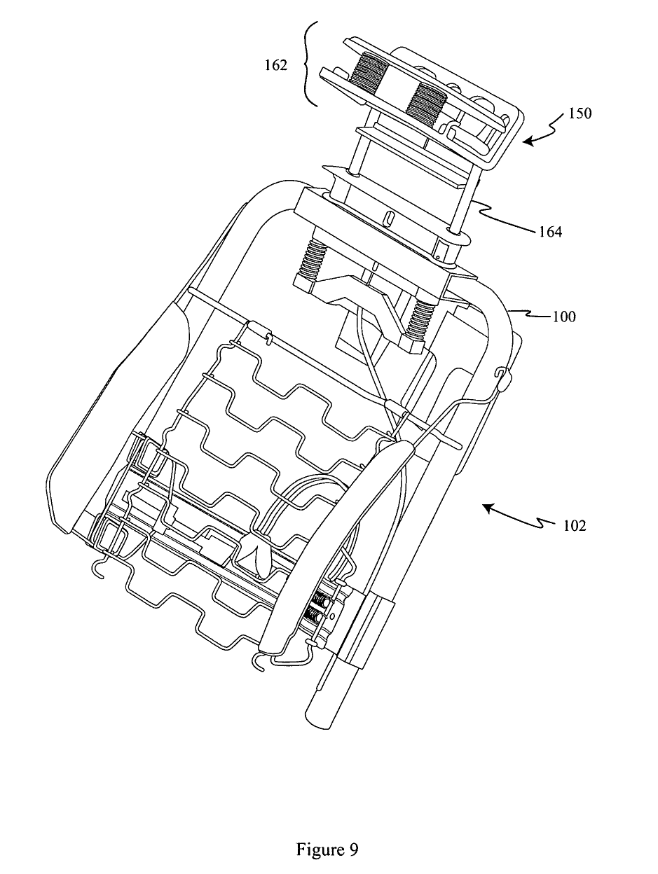

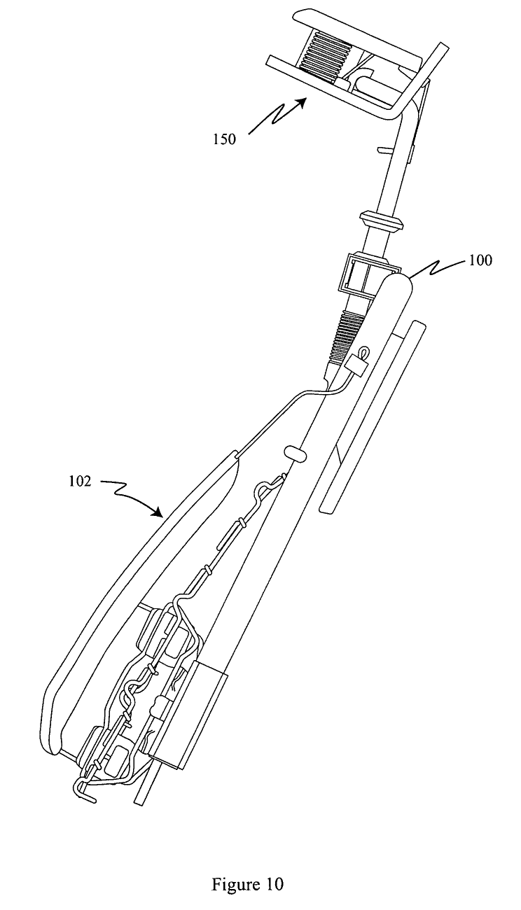

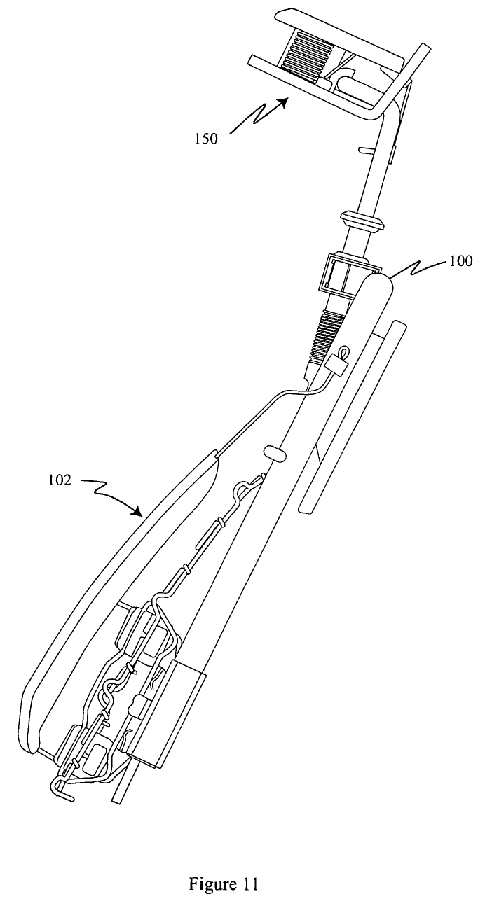

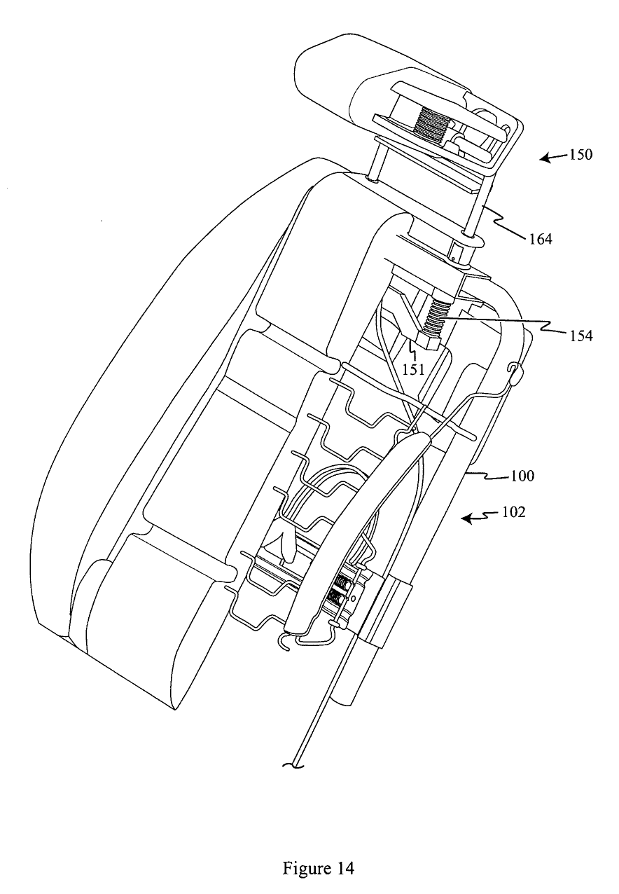

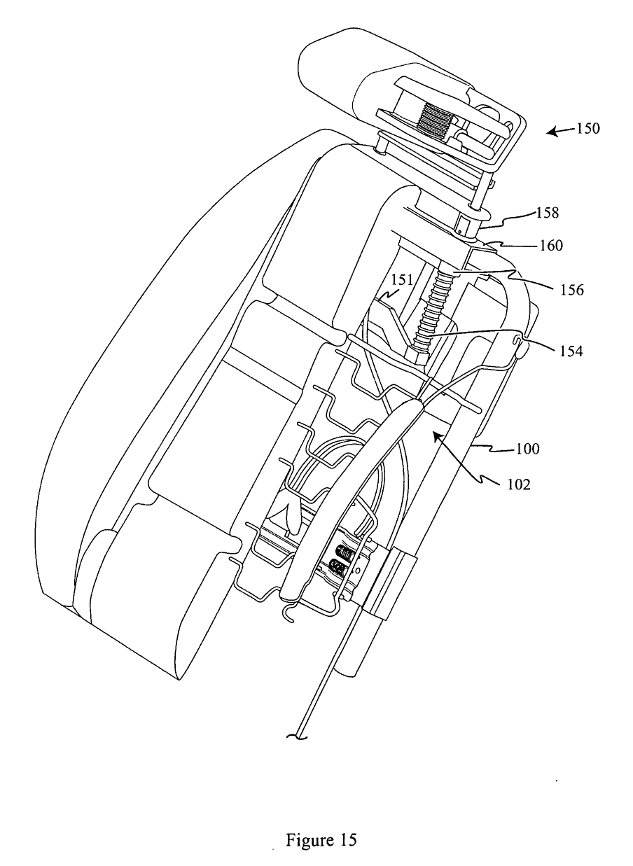

A seat frame 100 holds both a lumbar support assembly shown generally at 102, and a headrest assembly shown generally at 150. The lumbar support assembly 102 may be a movable lumbar suspension assembly as seen in FIGS. 1-5, 9-12, and 14-15.

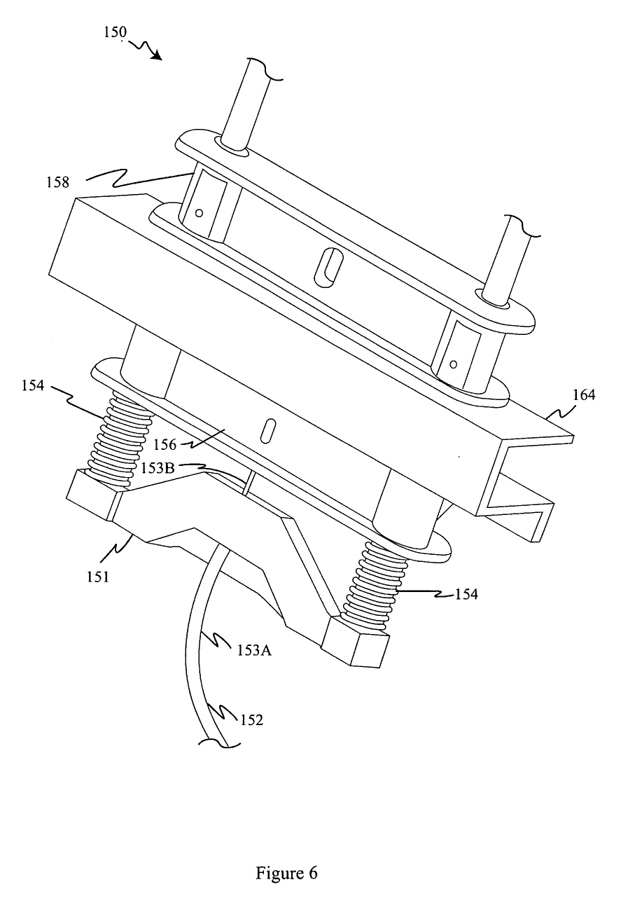

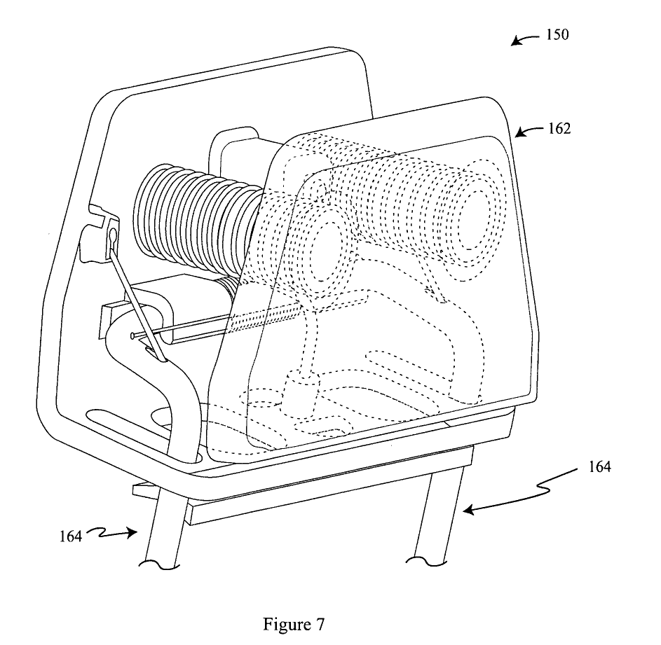

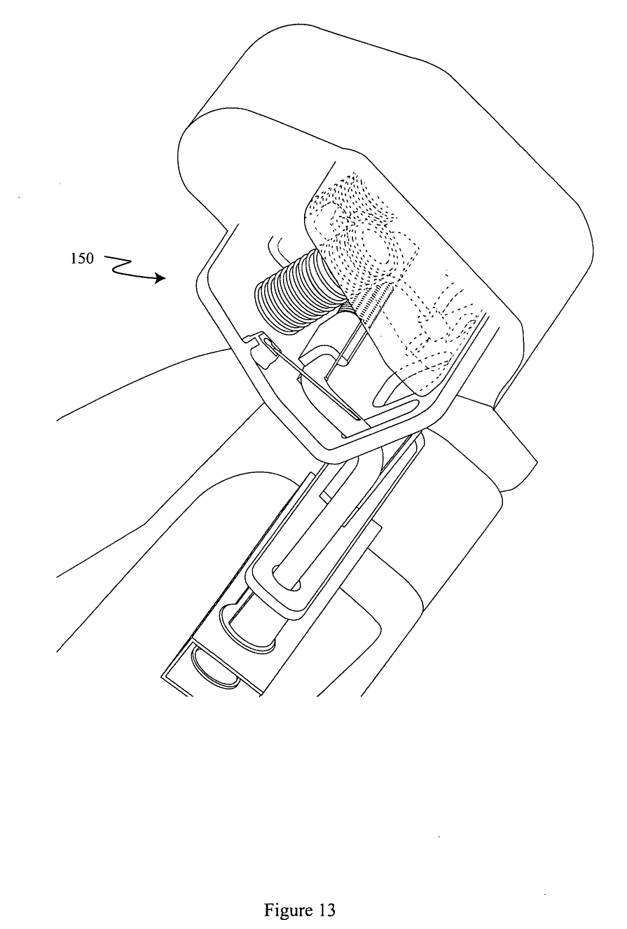

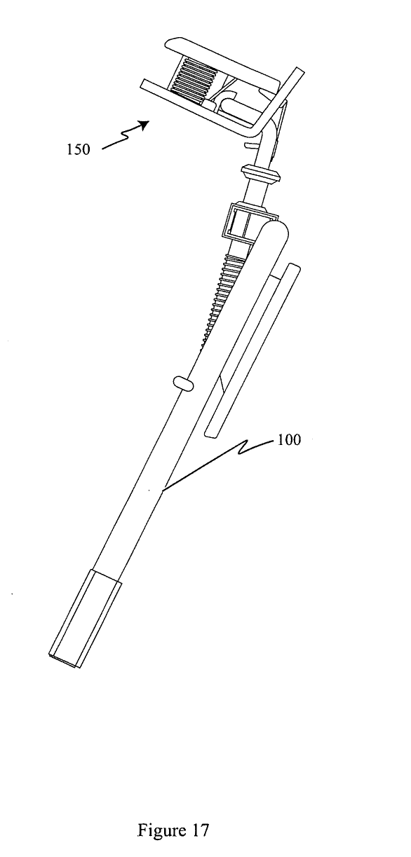

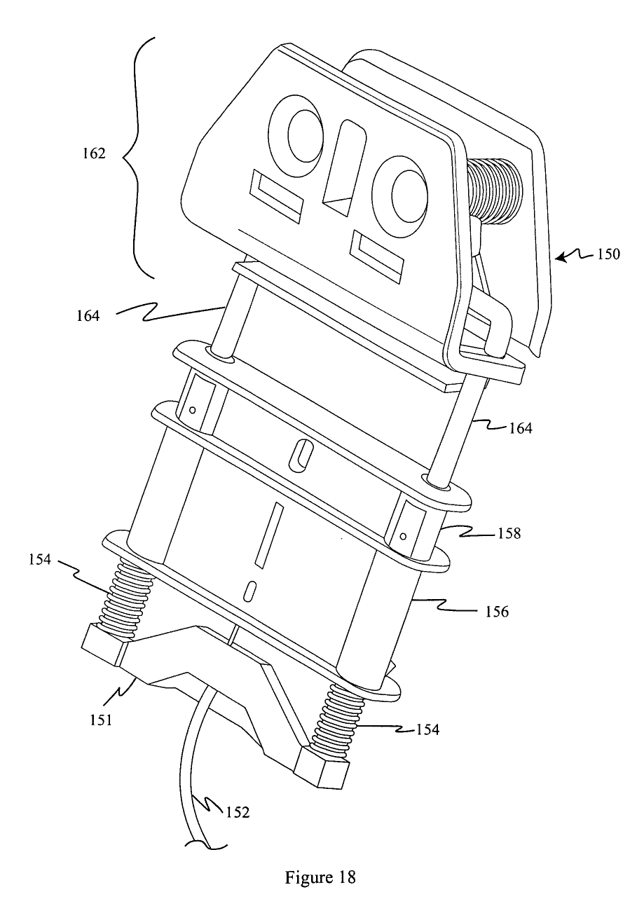

Headrest assembly 150 is mounted to seat frame 100, as best seen in FIGS. 1-6, and 9-17. As seen in all the Figures, but best seen in FIGS. 6, 7, and 18, headrest assembly 150 comprises a bracket 151, a Bowden cable 152, a pair of springs 154, a first slide member 156, a second slide member 158, a headrest frame bar 164 and an upper headrest assembly shown generally at 162. First and second slide members 156, 158 are attached to C-bracket 160.

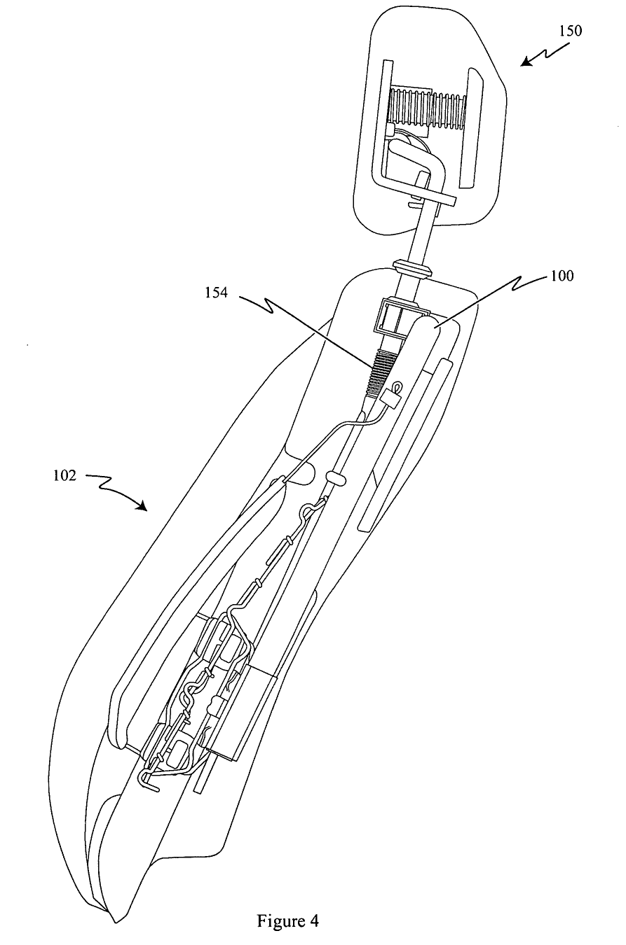

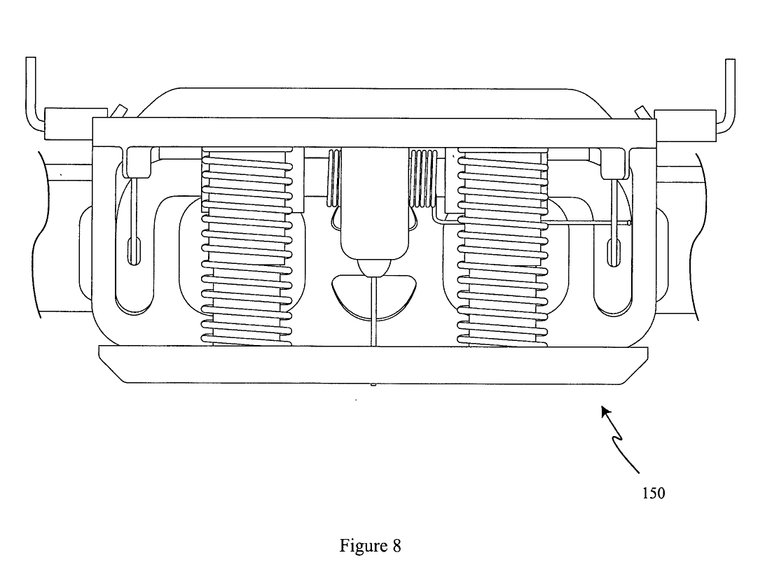

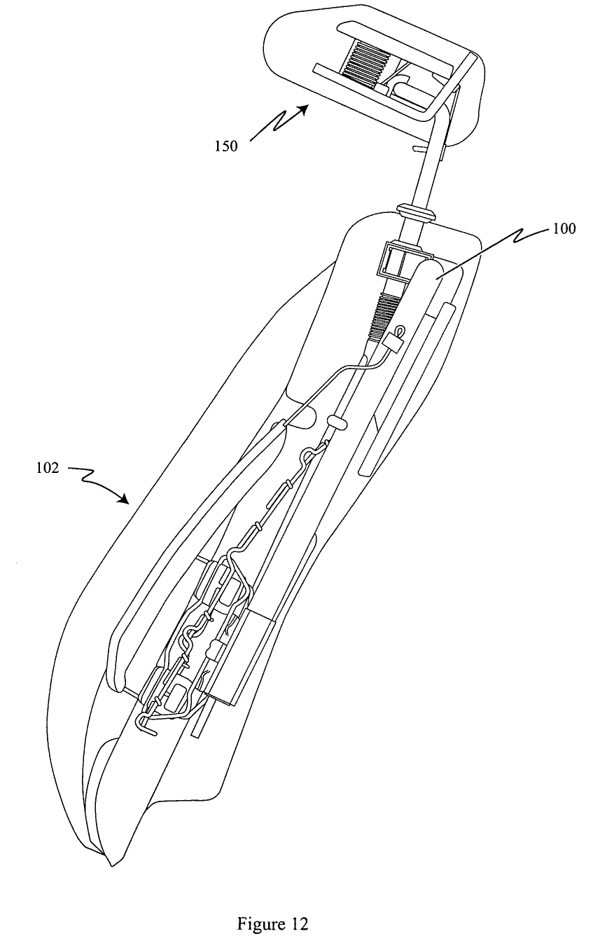

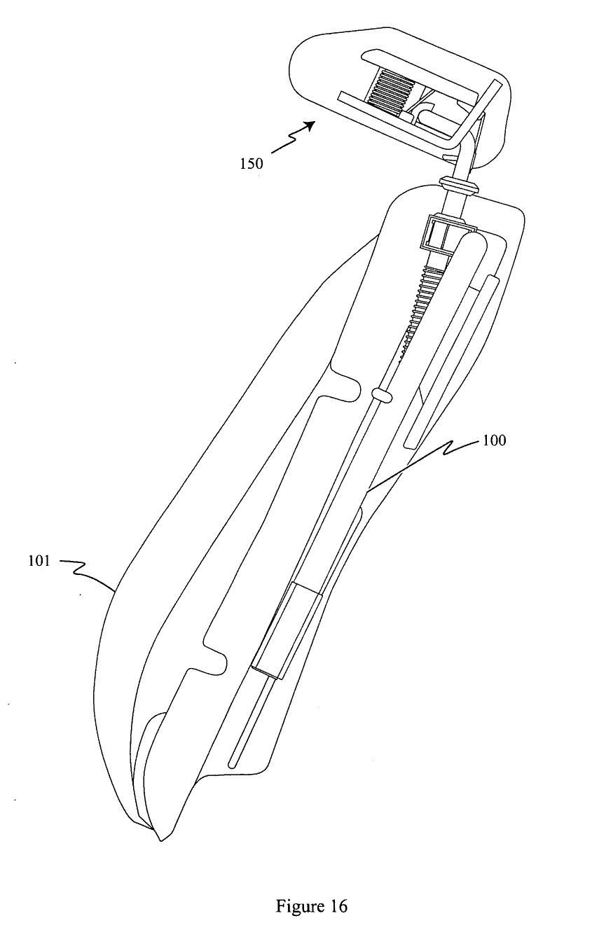

In operation, and referring to FIGS. 4, 12 and 16, seat 101 begins in an upright position (FIG. 4). When it becomes desirable to move the seat 101 to the down or stowed position, the seat back is moved to a down position seen in FIGS. 12 and 16. One end of Bowden cable 152 is attached to a fixed point on the floor or bottom seat frame. As best seen in FIG. 8, the other end of Bowden cable 152 has its conduit 153A attached to bracket 151, and its wire 153B attached to first slide member 156. Accordingly, during downward movement, Bowden cable wire is pulled due to the fixed distal connection, resulting in a tension that pulls first slide member 156 towards bracket 151. As first slide member 156 is moved towards bracket 151, second slide member 158 which is releasably and slidably connected to first slide member 156, also moves down towards bracket 151. It should be noted at this time that springs 154 provide bias for spacing first slide member 156 from bracket 151. Accordingly, the entire headrest assembly 150 is moved into seat 101.

Similarly, from an initially stowed position, as the seat 101 is moved into a deployed position, wire 153B of Bowden cable 152 is lengthened, and first slide member 156 is moved outward away from bracket 151.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A head rest assembly comprising:
a bracket;
a first slide member;
a pair of springs disposed between said bracket and said first slide member;
a Bowden cable having a first end comprising a conduit attached to said bracket and further comprising a wire attached to said first slide member;
wherein said pair of springs bias said bracket away from said first slide member.

2. A head rest assembly according to claim 1, further comprising:
a second slide member in sliding communication with said first slide member;
a headrest frame bar attached to said second slide member;
wherein movement of said first slide member away from said bracket causes movement of said second slide member away from said bracket; and
wherein movement of said first slide member towards said bracket causes movement of said second slide member towards said bracket.

3. A head rest assembly according to claim 1, further comprising a seat frame; and
wherein said Bowden cable comprises a second end fixed attached to said seat frame.
